(19) United States
(12) Patent Application Publication
(10) Pub. No.: US 2012/0213213 A1
(43) Pub. Date: Aug. 23, 2012

(54) METHOD OF PAIRING COMPUTER AND WIRELESS ELECTRONIC DEVICE

(75) Inventors: Tsung-Wen Hsueh, Taipei (TW); Shi-Jie Zhang, Taipei (TW); Chun-Nan Su, Taipei (TW)

(73) Assignee: PRIMAX ELECTRONICS LTD., Taipei (TW)

(21) Appl. No.: 13/076,775

(22) Filed: Mar. 31, 2011

(30) Foreign Application Priority Data
Feb. 18, 2011 (TW) 100105378

(51) Int. Cl. H04W 84/02

(52) U.S. Cl. 370/338

(57) ABSTRACT

A method of pairing a computer and a wireless electronic device includes the following steps. Firstly, a predetermined media access control address is received. A service set identifier of a wireless local network is established according to the predetermined media access control address. At least one packet is received. Then, a judging step is performed to judge whether the media access control address of the first packet matches the service set identifier. Afterwards, a response packet is transmitted to the wireless electronic device. By recording the media access control address of the wireless electronic device, the wireless electronic device to be paired can be accurately paired with the computer. It is more time-saving by using the pairing method of the present invention because the time period of selecting a to-be-paired wireless electronic device is not necessary.

### FIELD OF THE INVENTION

The present invention relates to a pairing method, and more particularly to a method of pairing a computer and a wireless electronic device.

### BACKGROUND OF THE INVENTION

With the maturity of a wireless transmission technology such as a bluetooth transmission technology or an infrared transmission technology, a variety of wireless electronic devices gradually replace the wired electronic device to be the common computer peripheral devices in our daily lives. For example, the common wireless electronic devices include wireless mice, wireless keyboard, wireless communication devices, or the like.

For allowing wireless communication between a wireless electronic device and a computer at a first time, a method of pairing the wireless electronic device and the computer is performed in order to successfully transmit date to the computer. Hereinafter, a conventional method of pairing a computer 10 and a wireless mouse 20 under a Microsoft Windows® series operating system will be illustrated with reference to FIG. 1.

FIG. 1 schematically illustrates a computer and some wireless electronic devices to be paired with the computer by a conventional pairing method. In FIG. 1, a computer 10 and some wireless electronic devices are shown. The computer 10 has a monitor 11. The wireless electronic devices include a wireless mouse 20, a wireless keyboard 21 and a wireless communication device 22. Firstly, the wireless mouse 20 is powered on. Then, a pairing key (not shown) of the wireless mouse 20 is pressed down, and thus the wireless mouse 20 generates and transmits a communication request message. Then, a wireless transmission function of the computer 10 is enabled. Through a built-in wizard of the Microsoft Windows® series operating system, a new wireless electronic device is added.

FIG. 2 is a flowchart illustrating a conventional method of pairing a computer and a wireless electronic device. In the step S10, the computer 10 starts to search for at least one wireless electronic device in a discoverable area of the computer 10. Then, in the step S11, a search list 111 is shown on the monitor 11 of the computer 10. Please refer to FIG. 3, which schematically illustrates the search list 111 created in the conventional method of pairing a computer and a wireless electronic device.

All of the wireless electronic devices searched by the computer 10 are shown on the search list 111 and have corresponding icons. For example, the search list 111 includes a mouse icon 210 corresponding to the wireless mouse 20, a keyboard icon 220 corresponding to the wireless keyboard 21 and a mobile phone icon 230 corresponding to the wireless communication device 22. These icons may facilitate the user to recognize the wireless electronic devices and select a desired wireless electronic device to be paired. After an icon corresponding to a wireless electronic device (e.g. the mouse icon 210 corresponding to the wireless mouse 20) is selected from the search list 111, the step S12 as shown in FIG. 2 is performed to pair the computer 10 and the wireless mouse 20.

However, the conventional pairing method still has some drawbacks. For example, in a case that many wireless electronic devices are in the discoverable area of the computer, the user needs to select a desired wireless electronic device from a lengthy search list. Consequently, it is time-consuming to select the wireless electronic device. Moreover, in a case that many wireless electronic devices of the same kind (e.g. a plurality of wireless mice) are in the discoverable area of the computer, it is inconvenient and troublesome for the user to select the desired wireless electronic device.

### SUMMARY OF THE INVENTION

The present invention provides a method of pairing a computer and a wireless electronic device in a time-saving and user-friendly manner.

In accordance with an aspect of the present invention, there is provided a method of pairing a computer and a wireless electronic device for establishing connection between the computer and the wireless electronic device. Firstly, a predetermined media access control address (MAC address) is received. Then, a service set identifier (SSID) of a wireless local network is established according to the predetermined media access control address. Then, at least one packet is received, wherein a first packet of the at least one packet includes a media access control address of the wireless electronic device. Then, a judging step is performed to judge whether the media access control address of the first packet matches the service set identifier. If the media access control address of the first packet matches the service set identifier, a response packet is transmitted to the wireless electronic device, so that a connection between the computer and the wireless electronic device is established.

In an embodiment, the first packet is a probe request frame.

In an embodiment, the response packet is a probe response frame.

In an embodiment, the first packet further contains a predetermined service set identifier, wherein the predetermined service set identifier is identical to the media access control address.

In an embodiment, the wireless electronic device further includes a pairing key, wherein by pressing down the pairing key, the wireless electronic device issues the first packet.

In an embodiment, the computer is operated in a Wi-Fi direct communication mode.

In an embodiment, the wireless electronic device is operated in a Wi-Fi direct communication mode.

In an embodiment, the wireless electronic device is a wireless input device, a wireless sound output device or a wireless communication device.

In an embodiment, the step of receiving the predetermined media access control address includes sub-steps of reading a bar code whose content contains the predetermined media access control address, and analyzing the content of the bar code to recognize the predetermined media access control address.

In an embodiment, the step of receiving the predetermined media access control address includes sub-steps of activating a pairing program, wherein the pairing program comprises a graphic user interface, and reading an input field of the graphic user interface to receive the predetermined media access control address from the input filed.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a computer and some wireless electronic devices to be paired with the computer by a conventional pairing method;

FIG. 2 is a flowchart illustrating a conventional method of pairing a computer and a wireless electronic device;

FIG. 3 schematically illustrates a search list created in the conventional method of pairing a computer and a wireless electronic device;

FIG. 4 schematically illustrates a computer and some wireless electronic devices to be paired with the computer by a pairing method according to an embodiment of the present invention; and

FIG. 5 is a flowchart illustrating a method of pairing a computer and a wireless electronic device.

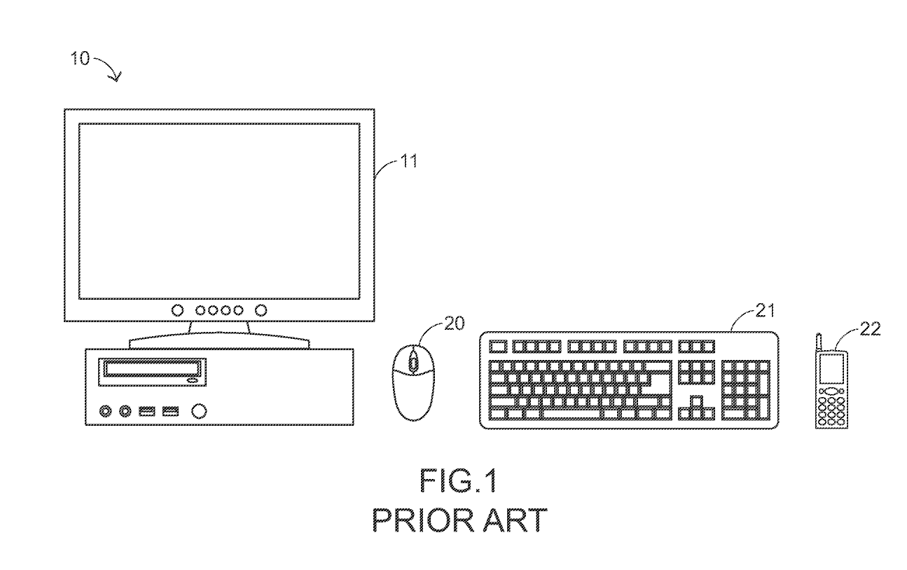

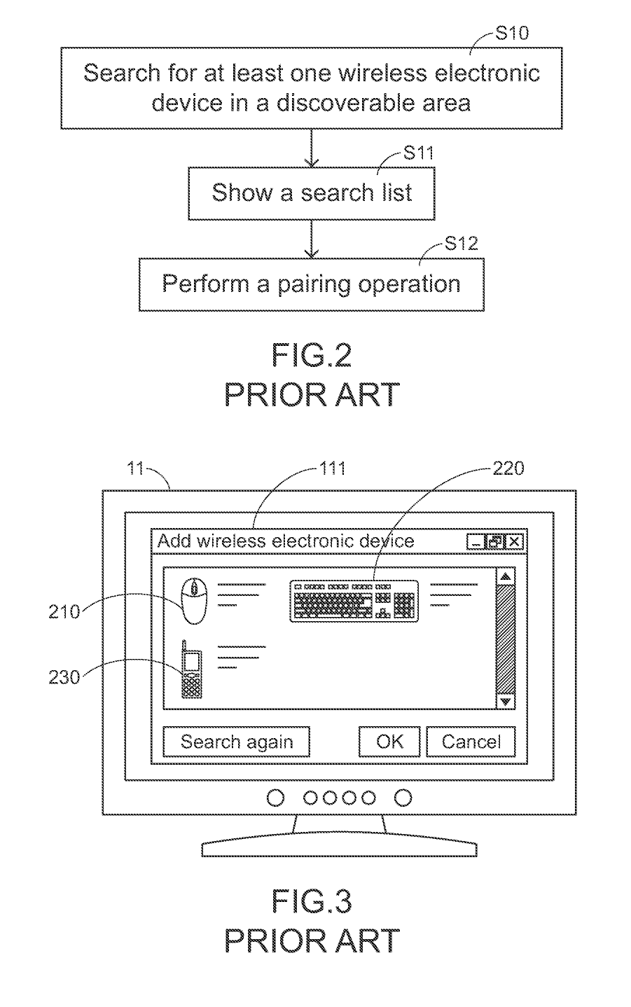

### DETAILED DESCRIPTION OF THE PREFERRED EMBODIMENT

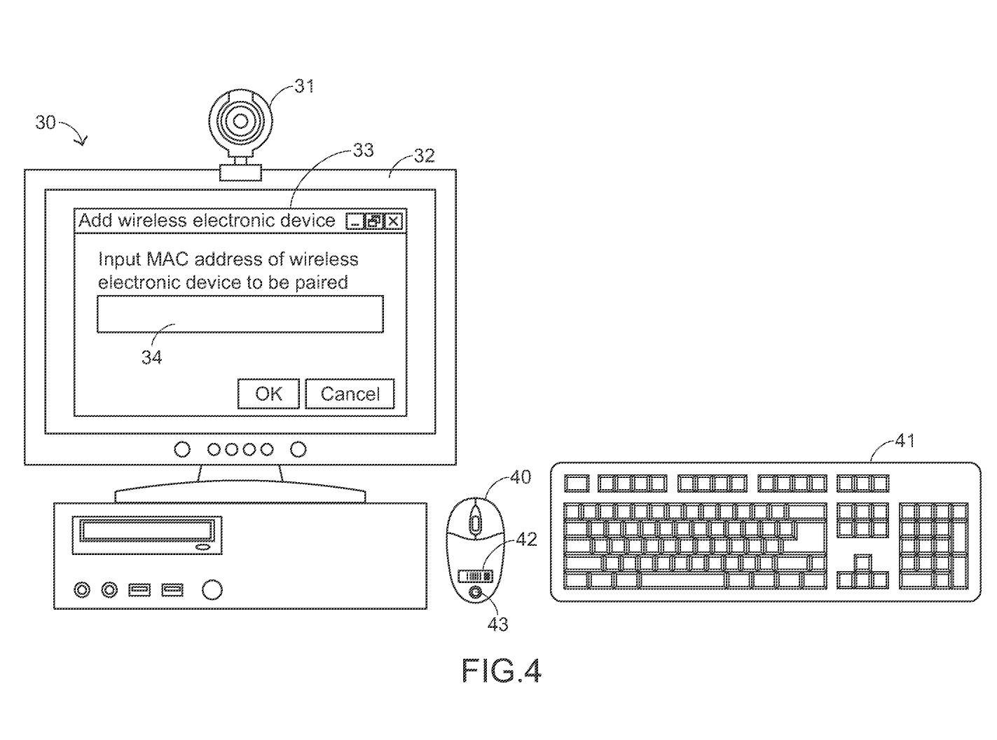

FIG. 4 schematically illustrates a computer and some wireless electronic devices to be paired with the computer by a pairing method according to an embodiment of the present invention. The wireless electronic device used in the present invention is for example a wireless input device (e.g. a wireless mouse or a wireless keyboard), a wireless sound output device (e.g. a wireless earphone or a wireless microphone) or a wireless communication device (e.g. a mobile or a personal digital assistant (PDA)). In the embodiment of FIG. 4, a computer 30 and two wireless electronic devices 40, 41 are shown. For example, the wireless electronic device 40 is a wireless mouse, and the wireless electronic device 41 is a wireless keyboard.

In this embodiment, the target wireless electronic device to be paired with the computer 30 is the wireless mouse 40. For simulating the real situation where one or more other wireless electronic devices are possibly located in the discoverable area, the wireless keyboard 41 as shown in FIG. 4 is referred as a non-target wireless electronic device. In this embodiment, the wireless communication interfaces used in the computer 30, the wireless mouse 40 and the wireless keyboard 41 are wireless fidelity (Wi-Fi) interfaces. The Wi-Fi interfaces are configured for transmitting data in a Wi-Fi direct communication mode.

The Wi-Fi direct communication mode is a software protocol developed by Wi-Fi Alliance. The Wi-Fi direct communication mode allows Wi-Fi devices to communicate with each other in a peer-to-peer (P2P) manner without the need for wireless access points.

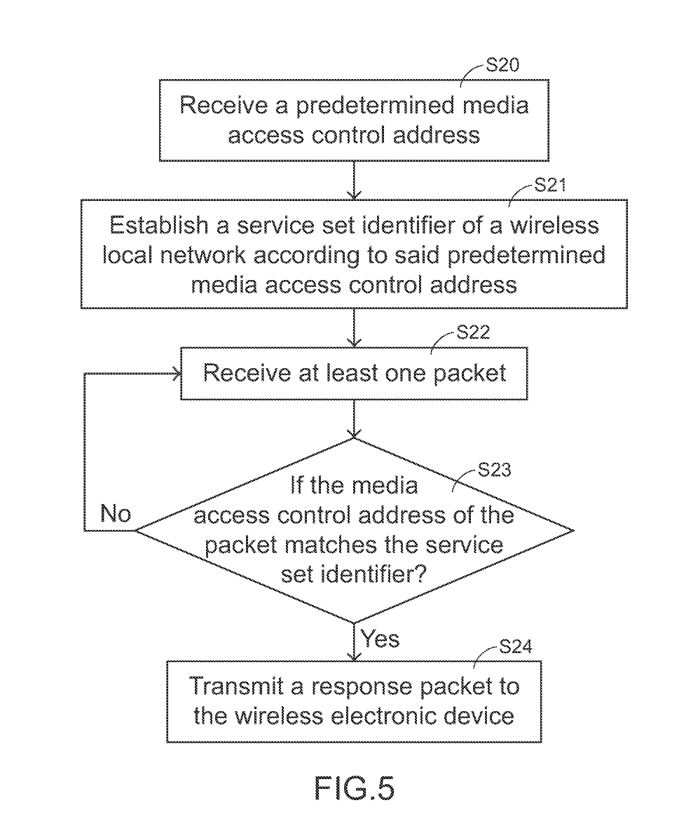

Hereinafter, a method of pairing a computer and a wireless electronic device will be illustrated with reference to FIG. 5. FIG. 5 is a flowchart illustrating a method of pairing a computer and a wireless electronic device. The contents of all steps will be illustrated in more details as follows.

Firstly, in the step S20, a predetermined media access control address (MAC address) from the surroundings is received by the computer 30. The predetermined media access control address is identical to the media access control address of the wireless mouse 40 that is being paired. Consequently, the wireless mouse 40 is recognized as a communication target by the computer 30. A media access control address is a unique identification code assigned to each wireless electronic device for defining the position of the wireless electronic device and distinguishing the wireless electronic device from other wireless electronic devices.

In an embodiment, the compute 30 receives a predetermined media access control address in an image input manner or a character input manner.

A step of allowing the computer to receive the predetermined media access control address in an image input manner will be illustrated as follows. Please refer to FIG. 4. The computer 30 has an image pickup device 31 such as a camera or a scanner. In addition, a bar code 42 is attached on the casing of the wireless mouse 40. The contents of the bar code 42 include the predetermined media access control address. Then, the image pickup device 31 of the computer 30 is used to read the bar code 42 of the wireless mouse 40, and the image of the bar code 42 is transmitted to the computer 30. Then, the contents of the bar code 42 are analyzed by an image recognition program to acquire the information associated with the predetermined media access control address.

A step of allowing the computer to receive the predetermined media access control address in a character input manner will be illustrated as follows. Please refer to FIG. 4. The computer 30 comprises a monitor 32 and a pairing program. The pairing program comprises a graphic user interface 33. The graphic user interface 33 comprises an input field 34 and an “OK” selective item. Firstly, the paring program of the computer 30 is activated, so that the graphic user interface 33 is shown on the monitor 32 to assist in pairing. Then, the media access control address is acquired by reading the mark on the casing of the wireless mouse 40 or the contents of the operating instruction. Then, via another peripheral input device (e.g. a keyboard) of the computer 30, the predetermined media access control address can be inputted into the input field 34. After the media access control address is inputted into the input field 34 and the “OK” selective item is clicked, the predetermined media access control address of the input field 34 is read and received by the computer 30.

Please refer to FIG. 5 again. After the step S20 of receiving the predetermined media access control address is performed by the computer, the step S21 is performed to allow the computer 30 to establish a wireless local network and establish a service set identifier (SSID) of the wireless local network according to the predetermined media access control address. For example, the service set identifier is an identification code consisted of at most 32 bits. The service set identifier is a name that identifies a particular wireless local network to distinguish the particular wireless local network from other wireless local networks.

After the wireless local network named as the predetermined media access control address has been successfully established, the computer 30 starts to receive various packets from the surrounding wireless electronic devices (in the step S22). For example, by pressing down a pairing key 43 of the wireless mouse 40, a first packet is transmitted from the wireless mouse 40. On the other hand, a second packet is transmitted from the non-target wireless keyboard 41.

The first packet is a probe request frame, which includes the media access control address of the wireless mouse 40 and carries a predetermined service set identifier. As a consequence, the first packet can implement a probe request to a particular wireless local network. In such way, the possibility of causing connection error is minimized because the first packet is not transmitted to other wireless local networks. Moreover, since the power consumption of the wireless mouse 40 is reduced, the endurance of the wireless mouse 40 is prolonged. In this embodiment, the predetermined service set identifier is predetermined to be identical to the media access control address of the wireless mouse 40. In other words, only the wireless local network with the service set identifier identical to the media access control address of the wireless mouse 40 is allowed to receive the first packet from the wireless mouse 40.

After at least one packet from the wireless electronic devices is received by the computer, the step S23 is performed to analyze the information of the packet to judge whether the media access control address included in the packet matches the service set identifier. If the condition of the step S23 is satisfied, the step S24 is performed. Whereas, if the condition of the step S23 is not satisfied, the step S22 is performed again to receive another packet. Hereinafter, a situation that a first packet and a second packet are simultaneously received by the computer 30 will be illustrated in more details.

After the first packet and the second packet are simultaneously received by the computer 30, either the first packet or the second packet is randomly selected to be analyzed. For example, if the second packet is selected to be analyzed, since the computer 30 judges that the media access control address included in the second packet does not match the service set identifier of the established wireless local network, the step S22 is performed again to receive another packet (e.g. the first packet). When the first packet is selected to be analyzed in the step S23, since the computer 30 judges that the media access control address included in the first packet matches the service set identifier of the established wireless local network, the step S24 is performed. In the step S24, a response packet is transmitted to the wireless mouse 40 through the media access control address included in the first packet in order to facilitate pairing the computer 30 and the wireless mouse 40.

It is noted that the response packet is a probe response frame. In addition, the pairing process is not influenced by the number of packets and the sequence of receiving the packets. In a case that only the first packet transmitted from the wireless mouse 40 is received in the discoverable area of the computer 30, the first packet is directly judged by the computer 30.

From the above description, the present invention provides a method of pairing a computer and a wireless electronic device. Firstly, a predetermined media access control address (i.e. the media access control address of the wireless mouse 40) is inputted into the computer 30. According to the predetermined media access control address, a service set identifier of a wireless local network is established. Consequently, during the process of pairing the computer 30 and the wireless mouse 40, the wireless mouse 40 can be accurately paired with the computer 30 without the need of selecting from the search list. In such way, the time period of selecting the wireless electronic device to be paired will be saved. Moreover, the pairing method of the present invention is more simple and convenient. In a case that many wireless electronic devices of the same kind are in the discoverable area of the computer, the pairing method of the present invention can prevent from the trouble and inconvenience of selecting a desired wireless electronic device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of pairing a computer and a wireless electronic device for establishing connection between said computer and said wireless electronic device, said method comprising steps of:
receiving a predetermined media access control address (MAC address);
establishing a service set identifier (SSID) of a wireless local network according to said predetermined media access control address;
receiving at least one packet, wherein a first packet of said at least one packet includes a media access control address of said wireless electronic device; and
judging whether said media access control address of said first packet matches said service set identifier, wherein if said media access control address of said first packet matches said service set identifier, a response packet is transmitted to said wireless electronic device, so that a connection between said computer and said wireless electronic device is established.

2. The method according to claim 1 wherein said first packet is a probe request frame.

3. The method according to claim 1 wherein said response packet is a probe response frame.

4. The method according to claim 1 wherein said first packet further contains a predetermined service set identifier, wherein said predetermined service set identifier is identical to said media access control address.

5. The method according to claim 1 wherein said wireless electronic device further comprises a pairing key, wherein by pressing down said pairing key, said wireless electronic device issues said first packet.

6. The method according to claim 1 wherein said computer is operated in a Wi-Fi direct communication mode.

7. The method according to claim 1 wherein said wireless electronic device is operated in a Wi-Fi direct communication mode.

8. The method according to claim 1 wherein said wireless electronic device is a wireless input device, a wireless sound output device or a wireless communication device.

9. The method according to claim 1 wherein said step of receiving said predetermined media access control address comprises sub-steps of:
reading a bar code, wherein a content of said bar code contains said predetermined media access control address; and
analyzing said content of said bar code to recognize said predetermined media access control address.

10. The method according to claim 1 wherein said step of receiving said predetermined media access control address comprises sub-steps of:
activating a pairing program, wherein said pairing program comprises a graphic user interface; and
reading an input field of said graphic user interface to receive said predetermined media access control address from said input filed.
